(19) United States
(12) Patent Application Publication
(10) Pub. No.: US 2004/0164101 A1
(43) Pub. Date: Aug. 26, 2004

(54) Fluid dispenser

(75) Inventors: Gerard Cornet, Blaru (FR); Firmin Garcia, Evreux (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS

(21) Appl. No.: 10/779,847

(22) Filed: Feb. 18, 2004

Related U.S. Application Data
(60) Provisional application No. 60/464,355, filed on Apr. 22, 2003.

(30) Foreign Application Priority Data
Feb. 20, 2003 (FR) FR-03/02082

(51) Int. Cl. B67D 1/00

(52) U.S. Cl. 222/200

(57) ABSTRACT

A fluid dispenser comprising: a fluid reservoir (1); at least one dispensing orifice through which the fluid is dispensed; a fluid feed duct (12) leading from the reservoir (1) towards the dispensing orifice, said duct being provided with an inlet and with an outlet; a valve (31, 61) for selectively closing off the feed duct, said valve comprising a moving valve member (31) mounted to move between a passageway-closure position and a passageway-opening position, the moving valve member being mounted to be moved in translation along a valve axis, the moving valve member (31) coming into leaktight abutment against a fixed valve seat (61), formed at the outlet of the feed duct (12), when in the passageway-closure position, and remaining away from said seat when in the passageway-opening position; said fluid dispenser being characterized in that it further comprises an outlet channel (32) formed by a sleeve (33) connecting the outlet of the duct (12) to the dispensing orifice, said sleeve having an elastically deformable segment (34), said moving valve member being situated inside said channel, said elastically-deformable segment urging the moving valve member into the passageway-closure position.

### CROSS REFERENCE TO RELATED APPLICATION

This application claims the benefit under 35 U.S.C. §119(e) of pending U.S. provisional patent application Serial No. 60/464,355, filed Apr. 22, 2003, and priority under 35 U.S.C. §119(a)-(d) of French patent application No. FR-03.02082, filed Feb. 20, 2003.

### TECHNICAL FIELD OF THE INVENTION

The present invention relates to a fluid dispenser comprising a fluid reservoir, at least one dispensing orifice through which the fluid is dispensed, a fluid feed duct connecting the reservoir to the dispensing orifice, a valve for selectively closing off the feed duct, and actuating means for moving the valve between a passageway-closure position and a passageway-opening position. Such a dispenser can be used, in particular, in the fields of perfumes, of cosmetics, or indeed of pharmaceuticals.

The present invention applies more particularly to a dispenser having a vibratory plate for generating vibration in the fluid so as to dispense it through the dispensing orifice(s). In order to start the vibratory plate vibrating, vibrator means are generally provided in the form of a piezoelectric element or of an ultrasonic resonant element. However, the invention is not limited to this particular type of dispenser having a vibratory plate. It is applicable to other types of dispenser that do not have vibratory plates.

### BACKGROUND OF THE INVENTION

Such a particular type of dispenser having a vibratory plate is known from Document FR 2 820 408 which describes a dispenser comprising a fluid reservoir, a dispensing member having a perforated vibratory plate, a feed duct connecting the reservoir to the vibratory plate, and an intake valve suitable for opening and closing the passageway formed by the feed duct. That valve comprises a metal ball urged by a spiral metal spring against a valve seat formed inside the feed duct. To disengage the ball from its seat, electromagnetic means are provided that make it possible to attract the ball away from its seat. The ball moves axially inside the duct, and the actuating means are controlled electrically.

### SUMMARY OF THE INVENTION

The present invention proposes an alternative solution to the intake valve having a metal ball urged by a metal spring.

In an embodiment of the invention, the fluid dispenser comprises: a fluid reservoir; at least one dispensing orifice through which the fluid is dispensed; a fluid feed duct leading from the reservoir towards the dispensing orifice, said duct being provided with an inlet and with an outlet; a valve for selectively closing off the feed duct, said valve comprising a moving valve member mounted to move between a passageway-closure position and a passageway-opening position, the moving valve member being mounted to be moved in translation along a valve axis, the moving valve member coming into leaktight abutment against a fixed valve seat, formed at the outlet of the feed duct, when in the passageway-closure position, and remaining away from said seat when in the passageway-opening position; the fluid dispenser further comprising an outlet channel formed by a sleeve connecting the outlet of the duct to the dispensing orifice, said sleeve having an elastically deformable segment, said moving valve member being situated inside said channel, said elastically-deformable segment urging the moving valve member into the passageway-closure position.

Thus, the moving valve member can be moved by elastically deforming the sleeve, which advantageously has shape memory that urges it into a state of least stress, corresponding to the passageway-closure position in this example. The moving valve member and the sleeve are preferably made integrally as a single piece.

In an aspect of the invention, said sleeve has a connection end mounted on the duct and a moving dispensing end forming means for receiving a piece of porous material urged away from said at least one dispensing orifice by the elastically deformable segment.

Advantageously, the dispenser further comprises actuating means for moving the moving valve member into its passageway-closure position, said actuating means being electromagnetic means.

In a practical embodiment, the actuating means comprise a fixed element and a moving element pushed away from the fixed element when fed with current, said moving element being constrained to move with the outlet channel.

Advantageously, the fixed element is constrained to move with the connection end and the moving element is constrained to move with the dispensing end.

Advantageously, the moving valve member is constrained to move with the dispensing end.

In another aspect of the invention, the sleeve is formed by a support piece provided with an elastically deformable diaphragm having an outer peripheral edge that is held in fixed manner, said diaphragm moving the moving member and the piece of porous material in translation axially.

Advantageously, the support piece is made integrally as a single piece.

Advantageously, in which the sleeve has a substantially rigid segment disposed between the dispensing end and the elastically deformable segment.

Advantageously, the moving valve member is constrained to move with the rigid segment.

Advantageously, the support piece is provided with an elastically deformable diaphragm having an outer peripheral edge that is held in fixed manner, said diaphragm moving the moving member and the piece of porous material in translation. Thus, the support piece may also be made integrally as a single piece by integrating the moving member, spring means, the outlet channel, the support for the piece of porous material, and the elastically deformable diaphragm.

In a preferred embodiment, the dispenser further comprises a vibratory plate that generates vibration in the fluid, said plate advantageously being vibrated by a piezoelectric element. Advantageously, said at least one dispensing orifice is formed through the vibratory plate. The use of such an intake valve is particularly advantageous when the dispenser has a vibratory plate which is advantageously perforated for dispensing the fluid in the form of a spray. This avoids any risk of the fluid leaking while the dispenser is not being used.

The principle of moving the porous material into contact with and away from the dispensing orifice(s) may be implemented independently, i.e. with or without the presence of an intake valve, and with any actuating means. In other words, moving the piece of porous material can be protected per se. The deformable sleeve, with or without a valve, constitutes a non-limiting mode of achieving the movement, and the electromagnetic actuating means constitute a non-limiting mode of achieving the actuation.

### BRIEF DESCRIPTION OF THE DRAWINGS

The invention is described more fully below with reference to the accompanying drawings which give a non-limiting example of an embodiment of the invention.

In the figures:

FIG. 1 is an overall section view of a fluid dispenser of the invention;

FIG. 2 is a greatly enlarged vertical section view of the dispensing portion of a fluid dispenser of the invention in the rest position; and

FIG. 3 is a view similar to the FIG. 2 view, in the in-use position.

### DETAILED DESCRIPTION OF THE INVENTION

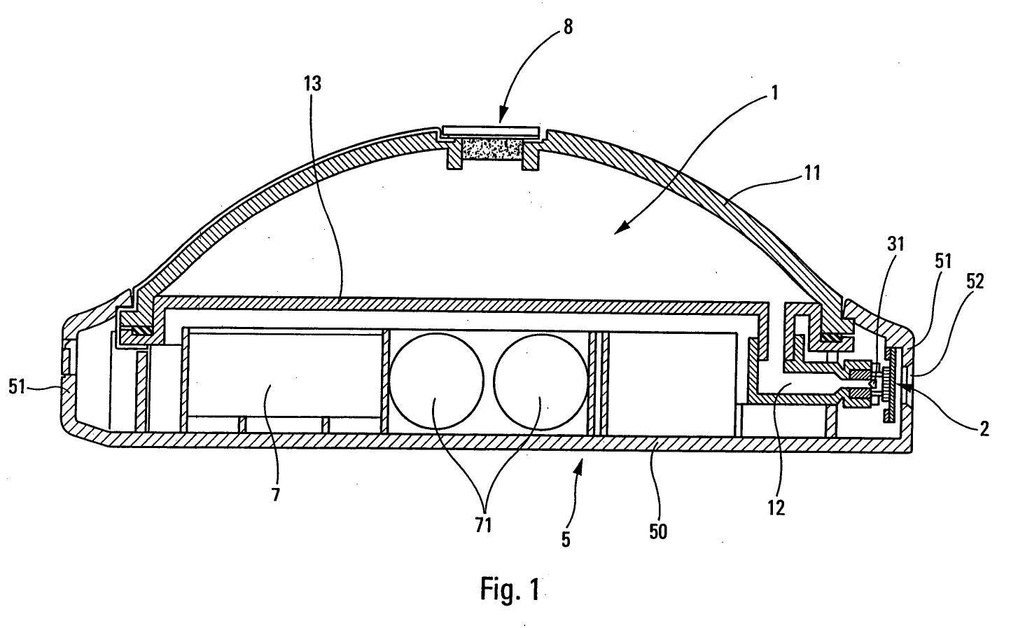

The fluid dispenser of the invention shown in FIG. 1 comprises a fluid reservoir 1 having a bottom wall or bottom 13 and a dome-shaped top wall 11, the walls defining between them the working volume of the reservoir. Naturally, the particular shape of the reservoir should not be considered to be limiting, so that the reservoir may be of any shape without going beyond the ambit of the invention. The top wall 11 of the reservoir is also provided with an actuating button 8 which is an electrical contact button, as explained below. In addition, a venting passageway may be formed at the top wall 11 under the actuating button 8.

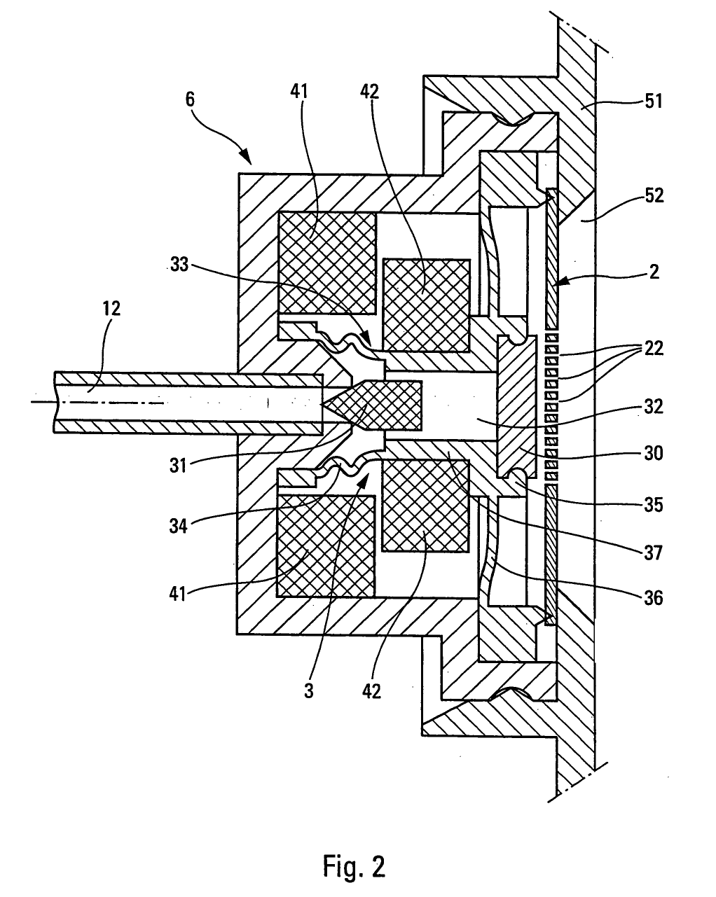

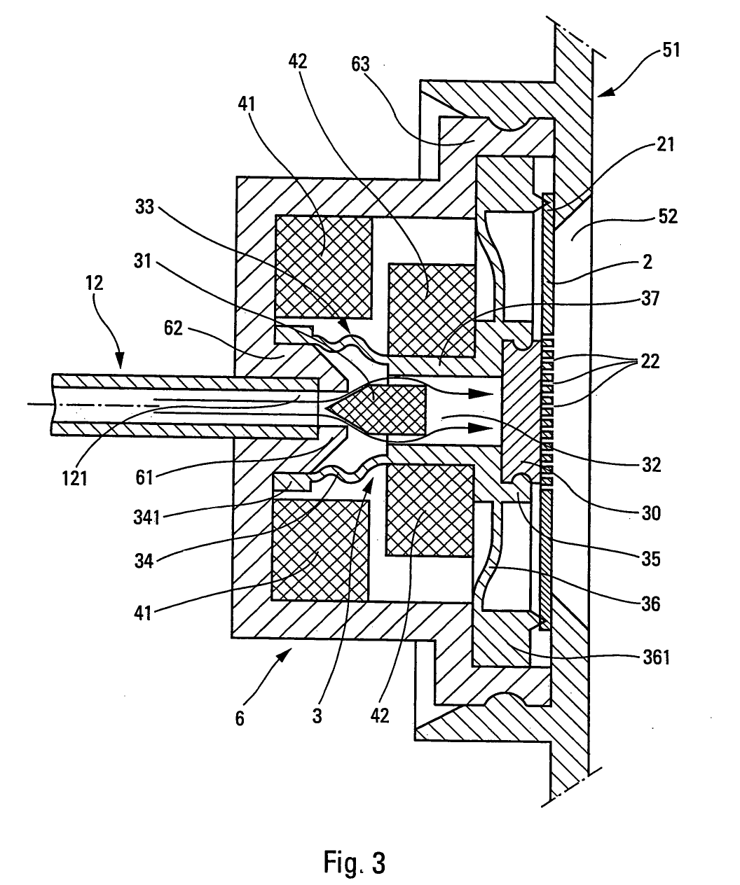

The dispenser further comprises a bottom shell 5 on which the reservoir 1 is mounted so as to define a plurality of compartments between the bottom wall 13 and the bottom shell 5. The bottom shell 5 has a substantially plane bottom wall 50 which serves as bearing surface on which the dispenser stands when it is put down on a substantially plane surface. The bottom shell 5 is also provided with a peripheral edge 51 to which the reservoir 1 is fixed. Among the compartments defined between the bottom wall 13 and the bottom shell 5, there is a compartment containing control electronics 7 making it possible to control the dispenser. In an adjacent compartment, there are two batteries 71 for powering the dispenser. In its right portion, as shown in FIG. 1, the dispenser also forms a feed duct 12 which leads from the reservoir 1 so as to feed the fluid to a composite dispensing member which makes it possible to dispense fluid from the dispenser. The dispensing member is disposed between the outlet of the duct 12 and a window 52 formed in the edge 51 of the bottom shell 5. The composite dispensing member is shown greatly enlarged in FIGS. 2 and 3, which show the dispensing member in the rest position and in the in-use position. Reference is therefore made below to FIGS. 2 and 3 to describe in detail the structure and operation of the composite dispensing member of the invention.

The composite dispensing member in this non-limiting embodiment of the invention comprises a vibratory plate 2 which, in this example, is advantageously perforated with a plurality of dispensing orifices 22. The dispensing orifices 22 may, for example, be arranged in the form of a grid-like array made up of rows and of columns of dispensing orifices. The vibratory plate, which may be flexible to some extent, may be associated with a vibration-generating element such as a piezoelectric element or a resonating element that resonates at very high frequency, such as an ultrasonic element. However, the vibratory plate may preferably be constituted by a piezoelectric layer associated with a non-piezoelectric layer so that the resulting plate is subjected to deformation by flexing when fed with a given current and with a given frequency. The plate 2 is held at its peripheral edge 21 so as to be fixed against the edge 51 of the bottom shell 5. Thus, when fed appropriately with current, with voltage, and with frequency, the vibratory plate starts to vibrate by means of a flexing deformation phenomenon, thereby ejecting fine droplets of fluid through the array of dispensing orifices 22. Naturally, for this purpose, it is necessary for the fluid coming from the reservoir 1 to be fed onto the rear face of the vibratory plate 2, i.e. its face facing towards the inside of the dispenser. The face facing towards the outside of the dispenser is situated in the window 52 formed by the bottom shell 5.

To feed the fluid onto the rear face of the vibratory plate 2, the outlet end 121 of the feed duct 12 communicates with the rear face of the vibratory plate 2 via an outlet channel 32 which connects the duct 12 to the plate 2. The outlet channel 32 is formed by a sleeve 33 which is an integral part of a support piece 3. More precisely, the outlet end 121 of the feed duct 12 is engaged in a ring 6 which is engaged at its outer peripheral edge 63 with the edge 51 of the bottom shell 5. The ring 6 forms an end-piece 62 inside which the end 121 of the duct 12 is in leaktight engagement. In addition, the end-piece 62 forms an intake valve seat 61 which is situated immediately after the end 121 of the duct 12. The sleeve 33 forms a leaktight fixing collar 341 in engagement around the end-piece 62 of the ring 6. The collar 341 forms an upstream connection end of the sleeve 33 internally defining the outlet channel 32. Beyond the collar, the sleeve 3 forms an elastically deformable segment 34 which nevertheless has shape memory so as to provide a return spring function. Beyond this return spring segment 34, the sleeve 33 forms a portion 37 that is more rigid and therefore substantially non-deformable, inside which a needle 31 is formed that acts as a moving valve member designed to come selectively into leaktight bearing contact against the valve seat 61 formed by the ring 6. In FIG. 2, the needle 31 is away from the seat 61, while in FIG. 3 the needle is in leaktight contact against its seat 61. In the invention, the return spring segment 34 urges the needle 31 towards and onto the seat 61 so as to close off the passageway for the fluid at the outlet of the duct 12. This position corresponds to the dispensing member being in the rest or storage position. The needle 31 which acts as a moving valve member occupies a portion of the cross-section of the sleeve 33 so that an annular passageway is formed around the needle 31 inside the sleeve 33 so as to enable the fluid coming from the duct 12 to pass beyond the needle 31 towards the vibratory plate 2.

The sleeve 3 also forms a fixing recess 35 for an piece of porous material 30. The fixing recess 35 is formed at the downstream end of the sleeve 33. The piece of porous material 30 which is received in fixed manner in the recess 35 closes off the outlet of the channel 32, so that the fluid coming from the duct 12 and passing around the needle 31 has to penetrate into the piece of porous material 30. In this way, the piece of porous material 30 becomes impregnated or soaked with fluid. Preferably, the piece of porous material 30 has capillary absorption properties. The piece of porous material 30 is urged by the return spring segment 34 formed by the support piece 3 into contact with the rear face of the vibratory plate 2, where the dispensing orifices are formed. Therefore, the return spring segment 34 both urges the needle 31 towards its seat 61 and urges the piece of porous material 30 away from the perforated vibratory plate 2.

The support piece 3 also forms a corolla-like diaphragm 36 which extends radially outwards from the fixing recess 35 and forms at its outer periphery a fixing bead 361 engaged between the ring 6 and the peripheral edge 21 of the vibratory plate 2. More precisely, the fixing edge 63 of the ring 6 pushes the bead 361 into bearing contact against the periphery 21 of the vibratory plate 2. The diaphragm 36 may have a resilient return function for assisting the return segment 34. However, above all, the diaphragm 36 has a function for guiding the sleeve 33 or holding it in alignment so that the piece of porous material 30 always comes into contact with the vibratory plate 2 at the same place, and can move along an axis perpendicular to the plane of the plate 2. The axis along which the piece of porous material 30 moves coincides with the axis along which the needle 31 moves. The sleeve 33 moving in axial translation in this way is made possible by the elastic deformation characteristics of the segment 34 and of the diaphragm 36. However, the sleeve 33 is held at its two ends, i.e. at the collar 341 and at the bead 361.

As explained above, the support piece 3 that supports both the moving valve member, namely the needle 31, and the piece of porous material 30, can move in translation axially along an axis that is perpendicular to the plane of the vibratory plate 2.

The composite dispensing member of the invention further comprises actuating means which make it possible to move the sleeve 33 between a starting first position (FIG. 2) in which the piece of porous material 30 is away from the vibratory plate and the needle 31 is in leaktight abutment against the seat 61 and a final second position (FIG. 3) in which the needle 31 is away from the seat 61 and the piece of porous material 30 is in contact with the rear face of the vibratory plate 2. These actuating means are electromagnetic actuating means. The actuating means comprise a fixed element 41 fixed to the ring 6 and therefore secured to the duct 12 and to the connection end of the sleeve 33. The actuating means further comprise a moving element 42 fixed to the rigid segment or portion 37 of the sleeve 33. When the actuating means are fed with current, a repulsion force is generated between the fixed and moving elements, the effect of which is to move the moving element away from the fixed element. Naturally, by moving, the moving element moves the rigid segment 37, the recess 35, the needle 31, and the piece of porous material 30 away from the valve seat 61 and towards the plate 2. The piece of porous material is then pressed against the rear face of the plate and the needle breaks its contact with the seat to open up a passageway at the outlet of the duct 12.

The fixed element may be a ferromagnetic element and the moving element may be an electromagnet, or vice versa.

Both elements may also be electromagnets.

An elastically deformable sleeve connecting the outlet of the feed duct to the dispensing orifices may be provided with a valve which acts elsewhere than at the outlet of the duct, e.g. at the dispensing orifices, in place of or in addition to the piece of porous material.

The sleeve may be an integral part of the duct.

The valve seat may be formed by the sleeve or by the support piece.

By means of the invention, it is guaranteed that the fluid dispenser cannot leak at the outlet of its feed duct 12.

1/ A fluid dispenser comprising:
a fluid reservoir (1);
at least one dispensing orifice through which the fluid is dispensed;
a fluid feed duct (12) leading from the reservoir (1) towards the dispensing orifice, said duct being provided with an inlet and with an outlet;
a valve (31, 61) for selectively closing off the feed duct, said valve comprising a moving valve member (31) mounted to move between a passageway-closure position and a passageway-opening position, the moving valve member being mounted to be moved in translation along a valve axis, the moving valve member (31) coming into leaktight abutment against a fixed valve seat (61), formed at the outlet of the feed duct (12), when in the passageway-closure position, and remaining away from said seat when in the passageway-opening position;
said fluid dispenser being characterized in that it further comprises an outlet channel (32) formed by a sleeve (33) connecting the outlet of the duct (12) to the dispensing orifice, said sleeve having an elastically deformable segment (34), said moving valve member being situated inside said channel, said elastically-deformable segment urging the moving valve member into the passageway-closure position.

2/ A dispenser according to claim 1, in which said sleeve has a connection end (341) mounted on the duct and a moving dispensing end (35) connected to the connection end through said deformable segment (34).

3/ A dispenser according to claim 1, further comprising actuating means (41, 42) for moving the moving valve member (31) into its passageway-closure position, said actuating means being electromagnetic means.

4/ A dispenser according to claim 1, in which the actuating means comprise a fixed element (41) and a moving element (42) pushed away from the fixed element when fed with current, said moving element being constrained to move with the outlet channel.

5/ A dispenser according to claim 4, in which the fixed element is constrained to move with the connection end and the moving element is constrained to move with the dispensing end.

6/ A dispenser according to claim 2, in which the moving valve member is constrained to move with the dispensing end.

7/ A dispenser according to claim 2, in which the moving dispensing end (35) forms means for receiving a piece of porous material (30) urged away from said at least one dispensing orifice by the elastically deformable segment (34).

8/ A dispenser according to claim 7, in which the sleeve is formed by a support piece (3) provided with an elastically deformable diaphragm (36) having an outer peripheral edge (361) that is held in fixed manner, said diaphragm (36) moving the moving member (31) and the piece of porous material (30) in translation axially.

9/ A dispenser according to claim 8, in which the support piece is made integrally as a single piece.

10/ A dispenser according to claim 2, in which the sleeve has a substantially rigid segment (37) disposed between the dispensing end and the elastically deformable segment.

11/ A dispenser according to claim 10, in which the moving valve member is constrained to move with the rigid segment.

12/ A dispenser according to claim 1, in which the moving valve member and the sleeve are made integrally as a single piece.

13/ A dispenser according to claim 1, further comprising a vibratory plate (2) that generates vibration in the fluid, said plate advantageously being vibrated by a piezoelectric element.

14/ A dispenser according to claim 13, in which said at least one dispensing orifice (22) is formed through the vibratory plate (2).
